(19) United States
(12) Patent Application Publication
(10) Pub. No.: US 2004/0047355 A1
(43) Pub. Date: Mar. 11, 2004

(54) Method of providing low cost network storage

(76) Inventors: Eric S. Brauel, Spring, TX (US); James J. Ganthier, Spring, TX (US)

Correspondence Address: Davis & Kendall, PC, Suite 626, 188 West Randolph, Chicago, IL, 60601, US

(21) Appl. No.: 10/235,071

(22) Filed: Sep. 6, 2002

(51) Int. Cl. H04L 12/56

(52) U.S. Cl. 370/401; 370/463; 370/465

(57) ABSTRACT

A method for implementing standard local area networks utilizing additional peripherals such as file and program storage devices, which combines the advantages of networked peripherals without the cost disadvantages. This is achieved by using the CPU memory of the LAN gateway to control low cost printers and storage devices.

### FIELD OF THE INVENTION

The invention relates to a method and apparatus for supporting additional peripherals in a computing network such as file and program storage and printers. More specifically, to a method of improving a LAN gateway that allow peripheral control for printers and other low cost storage devices.

### BACKGROUND OF THE INVENTION

File and program storage for a computer system is typically supported via the hard disk drive that is resident inside the chassis of the central processing unit (CPU). Upgrading or providing additional storage can be supported in two basic ways. The first way is for an additional storage device to be added inside the computer connected to the CPU via a high speed interconnect bus such as the IDE bus. Typically, this is a hard disk drive, cd-rw, or tape drive.

This type of storage upgrade may not be possible due to the design of the CPU chassis and, even if the CPU is designed for additional storage, this upgrade is complicated in that it requires the use of tools and a technical set up capability. Also, the sharing of computer files with other CPUs requires that some form of communications bus be present and requires that the CPU in which the hard drive is installed be powered on. The second way to support a storage upgrade is to connect a “networked” storage device external to the computer via a communications bus such as an Ethernet bus. This requires that a Local Area Network (LAN) be available but has the advantage of being relatively easy to physically connect the additional storage device by the user and does not require that a particular CPU be powered on at all times. The networked storage device has the disadvantage that it requires that the “networked” storage device be designed with a high performance processor that is capable handling the data flow from the hard drive as well as handling network protocols to transfer data via the Ethernet bus. This adds a significant cost to the networked storage peripheral relative to the non-networked storage peripheral.

Similarly, another common computing peripheral available in today's computing Systems is a printer. The lowest cost printers are designed with a very small amount of internal computing capability and rely on the computing power of the CPU to perform the bulk of the computing intensive printer control functions. This type of design works well for single CPU and printer computer installations but has severe limitations when installed in a LAN environment where several CPUs are present with each desiring to share the printer. In this situation, the CPU that is connected to the low cost printer, can be configured with software that allows the other CPUs to share the printer through the printer connected CPU. This has the disadvantage, however, of requiring additional computing bandwidth from this CPU to service the other CPUs printing requests and also requires that the printer connected CPU remain powered on at all times that printing is required by the other CPUs. A commonly available solution to these disadvantages is to utilize the “networked” printer. A “networked” printer, however, has the disadvantage that it requires that the “networked” printer be designed with a high performance processor that is capable of handling the printer control functions as well as handling the network protocols required to transfer data via the LAN.

### SUMMARY OF THE INVENTION

The invention provides a method for implementing standard local area networks utilizing additional peripherals such as file and program storage devices, which combines the advantages of networked peripherals without the cost disadvantages. This is achieved by using the CPU memory of the LAN gateway to control low cost printers and storage devices. It is an object of the invention to provide a low cost alternative to networked storage devices.

It is another objective of the invention to provide a low cost peripheral interface using commonly available bus structures.

Another objective of the invention is to use the processing power of the LAN gateway to present the storage peripheral to the network.

Finally, it is an object of the invention to reducing the computing requirements on the network.

### BRIEF DESCRIPTION OF THE DRAWINGS

FIG. 1 shows a standard network infrastructure.

FIG. 2 shows a block diagram of a LAN gateway.

FIG. 3 shows the network infrastructure with a peripheral interface.

FIG. 4 shows a block diagram of a LAN gateway with a peripheral interface.

### DETAILED DESCRIPTION OF THE INVENTION

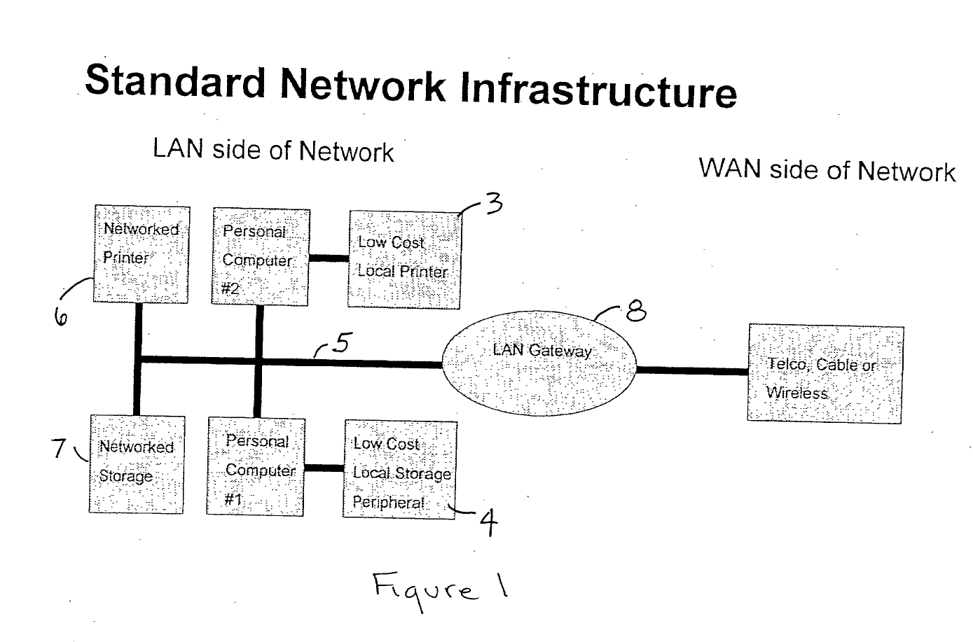

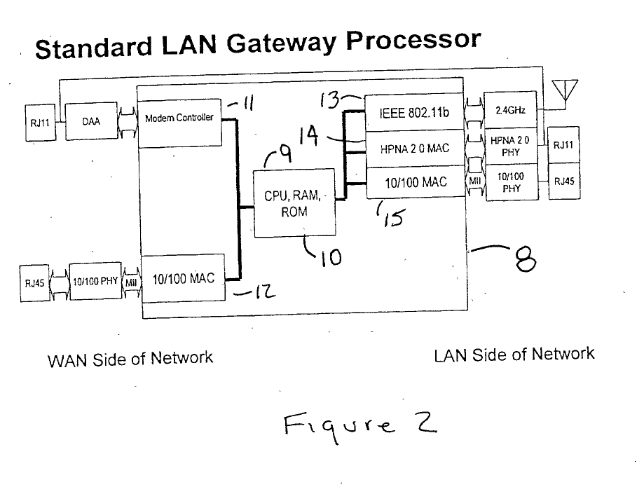

The instant invention utilizes the basic components that are required in implementing any standard local area network infrastructure. As shown in FIG. 1, a network structure includes a personal computer (1, and 2) having a local printer (3) or storage (4). They are connected to the network by cabling (5) or wireless connections (not shown). Networked printers (6) and storage (7) are also connected to the network allowing access by personal computers (1, and 2). Finally, a LAN gateway (8) allows access to thee WAN side of the network. A key component to LAN infrastructure is the LAN gateway (8). The LAN gateway (8) controls the data flow from the WAN side to the LAN side of the communications network as well as run various programs such as a firewall protection. Due to the high amount of computing required by the LAN gateway (8), it is designed utilizing a high performance processor. FIG. 2 shows the LAN gateway processor has the CPU (9), memory (10), and I/O control components (11-15) that are necessary to provide the LAN gateway control functions. The LAN gateway (8) must be kept powered on at all times to insure that the LAN is up and available at all times.

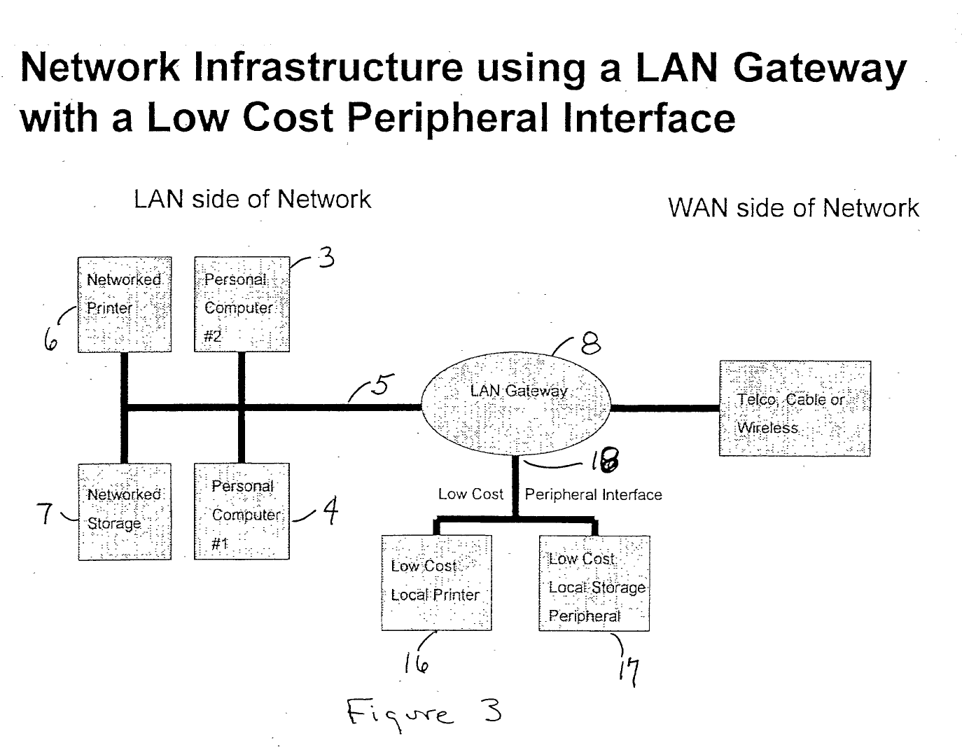

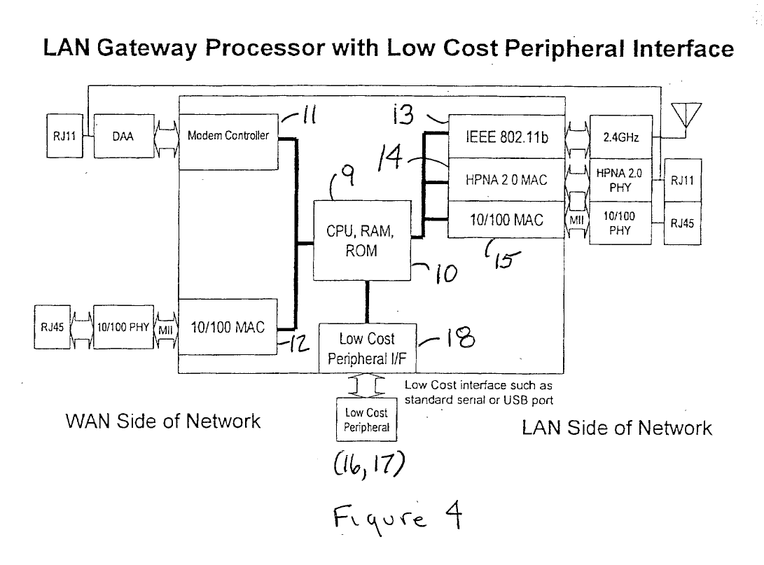

As shown in FIGS. 3, and 4 the instant invention changes the design and function of the LAN gateway (8) to add the additional capability of peripheral control. The LAN gateway is specially designed to have a “Low Cost Peripheral Interface” (LCPI) that is used to connect either a low cost printer (16) or low cost storage peripheral (17) or other computing peripheral that is desired to be “networked”. In the case of the printer (16), the processor intensive printer control functions could be performed by the LAN gateway processor (9) as an additional processor task using a multi-tasking software environment as well as presenting the printer to the LAN for use by other CPUs. In the case of the storage peripheral (17), the LAN gateway processor (9) can be used to present the storage peripheral (17) to the network. This reduces computing requirements and therefore the cost of the networked storage peripheral

The LCPI is implemented using the commonly available bus structures such as USB or Ethernet. The USB bus would be well suited for printers as many low cost printers are available with the USB interfaces. Storage peripherals could be connected via the USB bus as well but an Ethernet based interface would provide a higher data transfer rate and could be implemented with very low cost.

The invention has been described in detail with particular reference to certain preferred embodiments thereof, but it will be understood that variations and modifications can be effected within the spirit and scope of the invention.

PARTS LIST

| | |
|---|---|
| 1. | Personal Computer |
| 2. | Personal Computer |
| 3. | Local Printer |
| 4. | Storage Device |
| 5. | Network Cabling |
| 6. | Networked Printers |
| 7. | Storage Devices |
| 8. | LAN Gateway |
| 9. | CPU |
| 10. | Memory Device |
| 11. | I/O Control Component |
| 12. | I/O Control Component |
| 13. | 1/0 Control Component |
| 14. | I/O Control Component |
| 15. | I/O Control Component |
| 16. | Printer |
| 17. | Storage Peripheral |

What is claimed is:

1. A method of incorporating peripheral devices to a local area network (LAN) comprising:
a first personal computer;
a second personal computer in communication with said first personal computer;
a printer in communication with said first and second personal computers;
a storage device in communication with said first and second personal computer; and
a device in communication with said first and second personal computer, said printer, and said storage device which allows access to a wide area network, said device comprising a memory device, a CPU, I/O devices, and a peripheral interface.

2. The method of incorporating peripheral devices to a LAN as recited in claim 1 whereby the peripheral interface allows said device to control and allow access by said first and second personal computers to a storage device.

3. The method of incorporating peripheral devices to a LAN as recited in claim 2 whereby the peripheral interface allows said device to control and allow access by said first and second personal computer to a printer.

4. The method of incorporating peripheral devices to a LAN as recited in claim 3 whereby the peripheral interface is a USB port.

5. The method of incorporating peripheral devices to a LAN as recited in claim 4 whereby the peripheral interface is a serial port.

6. A method of storage in a local area network comprising:
providing a gateway to a wide area network;
a first personal computer in communication with said gateway;
a second personal computer in communication with said gateway and said first personal computer; and
said gateway further comprising a memory device, a CPU, I/O devices, and a peripheral interface.

7. The method as recited in claim 6 wherein said the peripheral interface allows said device to control and allow access by said first and second personal computers to a storage device.

8. The method as recited in claim 7 whereby the peripheral interface allows said device to control and allow access by said first and second personal computers to a storage device.

9. The method as recited in claim 8 whereby the peripheral interface is a USB port.

10. The method as recited in claim 8 whereby the peripheral interface is a serial port.
